(19) United States
(12) Patent Application Publication
(10) Pub. No.: US 2026/0209133 A1
(43) Pub. Date: Jul. 23, 2026

(54) SULFUR GRANULE WITH IMPROVED CRUSH STRENGTH

(71) Applicant: Tessenderlo Group NV, Brussels (BE)

(72) Inventors: Joshua Randall Raymond, Phoenix, AZ (US); Harry Charles Kominski, Phoenix, AZ (US)

(73) Assignee: Tessenderlo Group NV, Brussels (BE)

(21) Appl. No.: 19/141,091

(22) PCT Filed: Dec. 21, 2023
(86) PCT No.: PCT/EP2023/087334

§ 371 Date: Jun. 19, 2025

Related U.S. Application Data
(63) Continuation of application No. 18/145,046, filed on Dec. 22, 2022, now abandoned.

(51) Int. Cl. C05D 9/00; C05G 5/12

(52) U.S. Cl. CPC C05D 9/00; C05G 5/12

(57) ABSTRACT

The present invention relates to sulfur fertilizer granules having a sulfur content of at least about 90 wt. % and a crush strength of at least about 3.0 kgf. The present invention further relates to methods for the production of sulfur fertilizer granules by rotary drum granulation employing specific temperatures and water feed rates to achieve stable production of said sulfur fertilizer granules.

### FIELD OF THE INVENTION

The present invention relates to sulfur fertilizer granules. The present invention further relates to methods for the production of sulfur fertilizer granules by rotary drum granulation.

### BACKGROUND ART

Sulfur is part of the so-called secondary plant nutrients and like the primary nutrients (NPK), is essential for plant health and growth, although in lesser amounts than the primary nutrients. Sulfur is termed as the secondary nutrient only to refer to its quantity, not its importance in the healthy growth of the plants and crops. Sulfur is essential for nitrogen fixation in nodules on legumes, and it is necessary in the formation of chlorophyll. Plants use sulfur for producing proteins, amino acids, enzymes, and vitamins for a healthy growth. Sulfur generates resistance to disease. Most of the sulfur in soils is found in soil in organic matter. However, it is not available to plants in this form. In order to become available to plants, the sulfur must be first released from the organic matter and go through a mineralization process. The mineralization process is a result of microbial activity. In this process sulfur is converted to the sulphate form (SO₄²⁻), which is readily available to plants. Oil crops, legumes, forages and some vegetable crops require sulfur in considerable amounts. In many crops, its amount in the plant is similar to phosphorus. Although it is considered a secondary nutrient, it is now becoming recognized as the ‘fourth macronutrient’, along with nitrogen, phosphorus and potassium. Sulfur deficiency symptoms show up as light green to yellowish color. Deficient plants are small and their growth is retarded. Symptoms may vary between plant species. For example, in corn, sulfur deficiency shows up as interveinal chlorosis; in wheat, the whole plant becomes pale while the younger leaves are more chlorotic; in potatoes, spotting of leaves might occur.

The nutrient sulfur may be provided to the plant in many forms, including as a (bi)sulfate, thiosulfate, polysulfide, (bi)sulfite, elemental sulfur etc. In some applications, the provision of the nutrient sulfur in the form of elemental sulfur is desirable. In view of the complications and hazards associated with handling elemental sulfur powder, elemental sulfur fertilizer is generally applied in flaked, granular or pastille form. Due to its production process, a granule is essentially spherical, while a pastille generally has a flat bottom and a dome-shaped top. Although a significant portion of market share is dedicated to pastilles, in terms of handling and spreading properties granules are more advantageous.

The production of sulfur granules through rotary drum granulation is known in the art. Drum granulation uses atomizing nozzles to spray liquid sulfur and cooling water. The sulfur is cooled and solidified under influence of the cooling water. The inner wall of the drum is provided with inwardly extending lifting flights, whereby rotation of the drum causes the flights to lift solid sulphur particles from the bed of the granulation drum to an upper zone in the drum and to then drop the particles so that a curtain of solid sulphur particles falls toward the bed. With the rotation of the drum, the spherical sulfur particles are continuously picked up and grown under the influence of the liquid sulfur spray until the granulation is completed.

Controlling the rotary drum granulation of sulfur to achieve the desired particle size tends to be complicated, in a typical steady-state operation up to 50-60 wt. % of the granules produced are outside the desired particle size range and need to be reprocessed, which reduces the production capacity of the drum. Consequently, rotary drum granulators for sulfur fertilizer have an “oversized” footprint due to their low efficiency.

The crush strength of sulfur fertilizer granules or pastilles is an important factor which influences breakage and dust formation during transportation and handling. Achieving a high crush strength is especially challenging for sulfur fertilizers since the industrial-scale production processes typically result in amorphous sulfur (while mineral fertilizers may take a crystalline or semi-crystalline form).

Another important factor which influences the performance of sulfur fertilizer particles, in particular when a swelling clay is included in the sulfur fertilizer, is the degradation behaviour when contacted with water during application on the crop or soil and consequently how rapidly and completely the fertilizer particles break down into smaller particles. The agronomic performance of the sulfur fertilizer is considered to be higher if the product degrades quickly and completely into small particles. This is because smaller particle size equates to a higher surface area for colonization by soil bacteria, resulting in an efficient conversion rate of the elemental sulfur to mineralized sulfur i.e. sulfate that can be more readily utilized by a plant. The desire to provide quickly degrading fertilizer particles is difficult to reconcile with the desire to provide a high crush strength.

The problems outlined above, in particular the challenge of providing high crush strength granules, are particularly present when a swelling clay is included in the sulfur fertilizer.

The present inventors have identified that it would be desirable to provide improved sulfur fertilizer granule production methods, as well as the resulting granules, which are characterized by having a high crush strength and efficient processing, requiring little rework of off-spec material (in particular of granules outside targeted size range). In particular in case a swelling clay is included in the sulfur fertilizer granules. The present inventors have also identified that it would be desirable if these properties could be combined with good degradation behaviour.

WO2009/155682A1 discloses a method for the granulation of sulfur in a rotating drum.

U.S. Pat. No. 6,749,659B1 discloses a method for the granulation of a fertilizer comprising sulfur, clay and an additional fertilizer material.

U.S. Pat. No. 4,507,335A discloses an apparatus for producing sulfur granules comprising a seed generation and product growth zone.

It is an object of the present invention to provide sulfur fertilizer, in particular sulfur fertilizer comprising a swelling clay, having an improved crush strength, preferably in combination with good degradation behaviour.

It is an object of the present invention to provide an improved sulfur fertilizer manufacturing process which minimizes rework, in particular when a swelling clay is included in the sulfur fertilizer.

### SUMMARY OF THE INVENTION

The present inventors have found an optimized sulfur granule production process which achieves one or more objects of the invention. It was found that by careful control of the molten sulfur stream temperature, as well as the relative feed rates of molten sulfur and cooling water streams in a rotary drum granulation process, sulfur fertilizer granules comprising at least about 90 wt. % (by total weight of the granule) of sulfur and having a crush strength of at least about 3.0 kgf can be provided. As is shown in the appended examples, the methods described herein also result in significantly less rework of off-spec material, in particular in case granule sizes of between about 2 to about 4 mm are targeted. The obtained granules do not only have a high crush strength but also exhibit low friability, high hardness, are free flowing/non-sticking and maintain these properties after prolonged storage in humid atmosphere. The granules of the present invention are advantageous over granules with low hardness because the latter tend to be more friable, meaning that such granules are typically are prone to break apart resulting an increase in the amount of fine particles and dust generated within process equipment, leading to an increase in the downtime and reducing productivity of the manufacturing process, as well as during transport and storage, thus requiring the application of dust suppressants. In view of these advantageous properties, the obtained granules also do not require any dedusting oil coating (although it may be applied). Furthermore, the granules, when applied to the soil and/or crops in the field show a good degradation behavior.

Hence, in a first aspect, the present invention provides a sulfur fertilizer granule comprising at least about 90 wt. % (by total weight of the granule) of sulfur and having a crush strength of at least about 3.0 kgf.

In a preferred embodiment, the sulfur fertilizer granule has a diameter within the range of about 2 to about 4 mm.

In a preferred embodiment the sulfur fertilizer granule further comprises a clay mineral, preferably a clay material selected from kaolinites, illites, chlorites, vermiculites, and smectites (such as montmorillonites), and more preferably a clay mineral selected from smectites, such as montmorillonites. In a highly preferred embodiment, the clay mineral is bentonite.

The sulfur fertilizer granule preferably comprises 90-95 wt. % (by total weight of the granule) sulfur.

In a further aspect of the invention, there is provided a method for the production of a sulfur fertilizer granule comprising the following steps:
(a) providing a molten sulfur stream comprising at least 90 wt. % (by total weight of the molten sulfur stream) sulfur;
(b) providing an aqueous cooling stream;
(c) continuously feeding the molten sulfur stream of step (a) and the aqueous cooling stream of step (b) to a rotary drum granulator;
(d) continuously rotating the rotary drum granulator, thereby continuously forming sulfur fertilizer granules;
   characterized in that
   the molten sulfur stream of step (a) is fed to the rotary drum granulator in step (c) at a temperature within the range of 130-145° C.; and
   the ratio B: A is in the range of 0.018 to 0.068 liter/kg,
   wherein A is the feed rate of the molten sulfur stream (a), expressed in kg/minute,
   wherein B is the feed rate of the aqueous cooling stream (b), expressed in liter/minute.

In some embodiments, the method of the present invention further comprises step (a) with the steps:
(a1) providing sulfur;
(a2) providing the clay mineral; and
(a3) mixing the sulfur with the clay mineral at a temperature above the melting point of sulfur.

In a preferred embodiment, the step (a1) comprises providing molten sulfur and further comprises a step of degassing the molten sulfur in order to reduce the amount of H₂S in the molten sulfur.

In some embodiments, the method further comprises the step:
(e) recovering sulfur fertilizer granules from the rotary drum granulator.
   Preferably step (e) comprises separating the recovered sulfur fertilizer granules into a first fraction having a size within a predetermined size range, a second fraction having a size larger than the upper boundary of the predetermined size range and a third fraction having a size smaller than the lower boundary of the predetermined size range.

In a highly preferred embodiment of the invention wherein step (e) is performed, the predetermined size range is about 2 to about 4 mm and the first fraction represents more than 80 wt. % of the recovered sulfur fertilizer granules.

### BRIEF DESCRIPTION OF THE FIGURES

The present invention will now be described in more detail with reference to specific embodiments of the invention, given only by way of illustration, and with reference to the accompanying drawings.

FIG. 1 is a schematic of the granulation process and shows an implementation of the process according to a preferred embodiment of the present invention wherein the molten sulfur stream comprises clay.

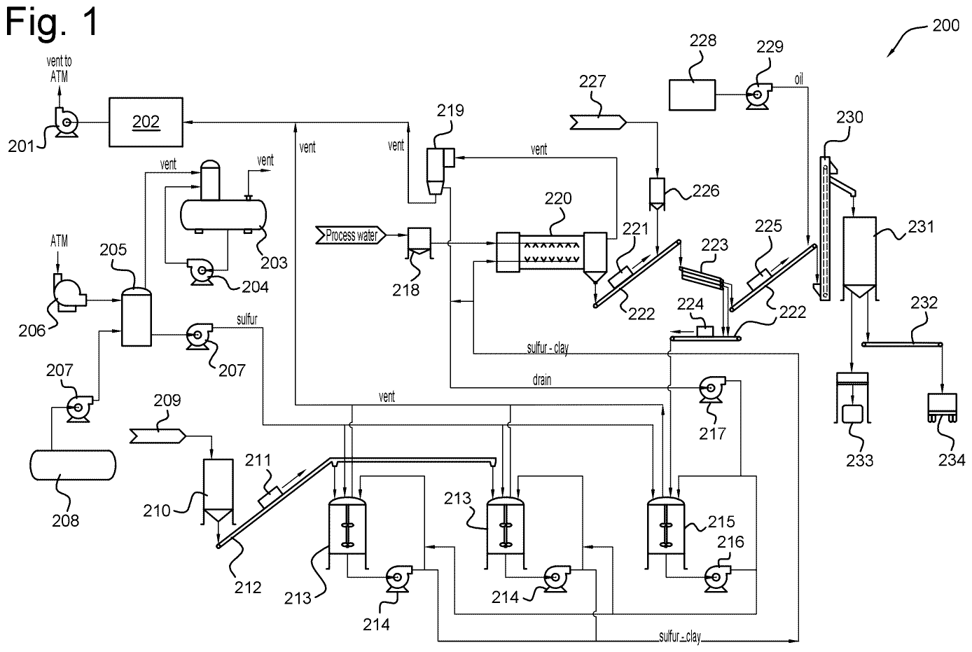

References: 200—process diagram, 201—exhaust fan, 202—wet scrubber, 203—sulfur vent scrubber, 204—sulfur vent scrubber pump, 205—sulfur degassing tank, 206—sulfur degasser blower, 207—sulfur pump, 208—sulfur tank, 209—bentonite from super sack, 210—clay feed hopper, 211—clay, 212—clay feed conveyor, 213—mix tank, 214—mix tank feed pump, 215 rework tank, 216—rework tank feed pump, 217—drain pump, 218—process water tank, 219 cyclone, 220—granulation drum, 221—sulfur-clay granules, 222—conveyor, 223—screen, 224 oversize/fines, 225—final product, 226—sulfur bentonite bag unloader, 227—clay from super sack, 228—oil tote, 229—oil treatment pump, 230—bucket elevator, 231—dry sulfur storage silo, 232 weigh feeder/conveyor, 233—super sack filing station, 234—sulfur-clay fertilizer truck loading.

### DESCRIPTION OF EMBODIMENTS

The expression “comprise” and variations thereof, such as, “comprises” and “comprising” as used herein should be construed in an open, inclusive sense, meaning that the embodiment described includes the recited features, but that it does not exclude the presence of other features, as long as they do not render the embodiment unworkable.

The expressions “one embodiment”, “a particular embodiment”, “an embodiment” etc. as used herein should be construed to mean that a particular feature, structure or characteristic described in connection with the embodiment is included in at least one embodiment. Thus, the appearances of such expressions in various places throughout this specification do not necessarily all refer to the same embodiment. Furthermore, the particular features, structures, or characteristics may be combined in any suitable manner in one or more embodiments. For example, the features of the disclosure which are described herein in the context of separate embodiments are also explicitly envisaged in combination in a single embodiment.

The singular forms “a,” “an,” and “the” as used herein should be construed to include plural referents unless the content clearly dictates otherwise. It should also be noted that the term “or” is generally employed in its broadest sense, that is as meaning “and/or” unless the content clearly dictates otherwise.

Whenever reference is made throughout this document to a compound which is a salt, this should be construed to include the anhydrous form as well as any solvates (in particular hydrates) of this compound, unless explicitly defined otherwise.

The present invention will now be described in more detail with reference to specific embodiments of the invention, given only by way of illustration, and with reference to the accompanying drawings.

The expression “about” as used herein in conjunction with a number is preferably construed as disclosing the number ±10%. Any value recited herein in conjunction with the expression “about” is in a preferred embodiment of the invention the same value without the word “about” (for example “about 4 mm” is preferably “4 mm”).

The term “sulfur” used in the context of the process and the sulfur fertilizer granule of the present invention is used to denote elemental sulfur, i.e. compounds consisting of sulfur in the oxidation state 0, typically in the form of S₈ molecules. The sulfur may originate from a refinery gas stream treated to produce elemental sulfur e.g. via the Claus process. Alternatively, the sulfur may originate from a bio-based process (applied to a refinery gas stream or another precursor) which employs microorganisms such as bacteria to produce elemental sulfur. Such a bio-based production process of sulfur is known for example as THIOPAQ®.

The crush strength of a granule as referred to herein is preferably determined using a Torontech portable hardness tester TAB series, such as the portTAB-01.

### The Sulfur Fertilizer Granule and Compositions Comprising Said Granule

In a first aspect, the present invention provides a sulfur fertilizer granule comprising at least 90 wt. % (by total weight of the granule) of sulfur and having a crush strength of at least about 3.0 kgf. In accordance with the invention, the granule preferably is substantially spherical, as is obtainable by rotary drum granulation production of granules.

Such granules are obtainable by the production methods described herein. The present inventors have determined the average crush-strength on 30 pastilles of commercially available 90 wt. % sulfur product (Tiger 90CR®) is 2.15 kgf. This crush strength was determined by side-to-side crushing, i.e. the weak side of the pastille. However, it is the weakest crush strength of a product which determines its overall performance. The granules according to the invention have a uniform crush strength and do not suffer from a “strong” side and a “weak” side.

The sulfur fertilizer granule preferably has a crush strength of at least about 3.2 kgf, more preferably at least about 3.4 kgf, most preferably at least about 3.6 kgf.

The sulfur fertilizer granule preferably has a diameter within the range of about 2 to about 4 mm, preferably within the range of about 2.5 to about 4 mm.

In highly preferred embodiments of the invention, the sulfur fertilizer granule comprises a clay mineral. The clay mineral is preferably a swelling clay, such as a clay selected from kaolinites, illites, chlorites, vermiculites, and smectites (such as montmorillonites), and more preferably a clay mineral selected from smectites, such as montmorillonites. The clay is most preferably bentonite. The sulfur fertilizer granule preferably comprises at least about 4 wt. % (by total weight of the granule) of the clay mineral, preferably at least about 8 wt. % (by total weight of the granule) of the clay mineral. Thus, the sulfur fertilizer granule preferably comprises at least about 4 wt. % (by total weight of the granule) bentonite, preferably at least about 8 wt. % bentonite. In some embodiments the sulfur fertilizer granule comprises about 3-8 wt. % of bentonite.

In preferred embodiments of the invention, particularly those embodiments where the fertilizer granule comprises a clay mineral as described herein, the sulfur fertilizer granule is characterized by a fraction of at least 40 wt. % preferably at least 45 wt. %, more preferably at least 48.5 wt. %, most preferably at least 50 wt. % of particles having a particle size of less than 315 micron when tested according to the degradation test protocol described herein.

In some embodiments of the invention, the sulfur fertilizer granule consists essentially of sulfur, such that the granule comprises at least 95 wt. % (by total weight of the granule) sulfur, preferably at least 98 wt. % (by total weight of the granule) sulfur, more preferably at least 99 wt. % (by total weight of the granule) sulfur.

In preferred embodiments of the invention, the sulfur fertilizer granule comprises clay as described herein earlier, and comprises 90-95 wt. % (by total weight of the granule) sulfur.

The sulfur fertilizer granule may comprise one or more further fertilizing ingredients, such as a source of macronutrients selected from N, P, K, S, Ca, or Mg and/or a source of micronutrients selected from Fe, B, Mn, Zn, Cu, Mo, Ni, V, Co. The sulfur fertilizer granule may also comprise a dedusting oil coating, such as a mineral, vegetable, seed and/or synthetic oils coating, preferably a vegetable oil coating. The present inventors have found that the granules obtainable by the process described herein do not require a dedusting oil coating to have acceptable dust levels. Hence, in some embodiments the fertilizer granule of the invention is essentially free of dedusting oil, such as essentially free of vegetable oil.

In general, the fertilizer granule will also comprise low amounts of moisture, and low amounts (typically <0.5 wt. %) of impurities other than sulfur, clay and optional further fertilizing ingredients.

Hence, as will be understood from the above, a particularly preferred sulfur fertilizer granule according to the invention is a sulfur fertilizer granule which:
comprises at least about 90 wt. % (by total weight of the granule) of sulfur;
comprises at least about 4 wt. % (by total weight of the granule) of a clay mineral, preferably bentonite;
has a diameter within the range of about 2 to about −4 mm; and
has a crush strength of at least about 3.0 kgf, preferably at least about 3.2 kgf, preferably of at least about 3.4 kgf, more preferably of at least about 3.6 kgf.

Preferably there is provided a sulfur fertilizer granule which:
comprises about 90-95 wt. % (by total weight of the granule) of sulfur;
comprises at least about 4 wt. % (by total weight of the granule) of bentonite;
has a diameter within the range of about 2 to about 4 mm; and
has a crush strength of at least about 3.0 kgf, preferably at least about 3.2 kgf, preferably of at least about 3.4 kgf, more preferably of at least about 3.6 kgf.

Preferably there is provided a sulfur fertilizer granule which:
comprises about 90-92 wt. % (by total weight of the granule) of sulfur;
comprises at least about 8 wt. % (by total weight of the granule) of bentonite;
has a diameter within the range of about 2 to about 4 mm; and
has a crush strength of at least about 3.0 kgf, preferably at least about 3.2 kgf, preferably of at least about 3.4 kgf, more preferably of at least about 3.6 kgf.
An even more preferred sulfur fertilizer granule according to the invention is a sulfur fertilizer granule which:
comprises at least about 90 wt. % (by total weight of the granule) of sulfur;
comprises at least about 4 wt. % (by total weight of the granule) of a clay mineral, preferably bentonite;
has a diameter within the range of about 2 to about 4 mm;
has a crush strength of at least about 3.0 kgf, preferably at least about 3.2 kgf, preferably of at least about 3.4 kgf, more preferably of at least about 3.6 kgf; and
is characterized by a fraction of at least about 40 wt. % preferably at least about 45 wt. %, more preferably at least about 48.5 wt. %, most preferably at least about 50 wt. % of particles having a particle size of less than about 315 micron when tested according to the degradation test protocol described herein.

Preferably there is provided a sulfur fertilizer granule which:
comprises about 90 to about 95 wt. % (by total weight of the granule) of sulfur;
comprises at least about 4 wt. % (by total weight of the granule) of bentonite;
has a diameter within the range of about 2 to about 4 mm;
has a crush strength of at least about 3.0 kgf, preferably at least about 3.2 kgf, preferably of at least about 3.4 kgf, more preferably of at least about 3.6 kgf; and
is characterized by a fraction of at least about 40 wt. % preferably at least about 45 wt. %, more preferably at least about 48.5 wt. %, most preferably at least about 50 wt. % of particles having a particle size of less than about 315 micron when tested according to the degradation test protocol described herein.

Preferably there is provided a sulfur fertilizer granule which:
comprises about 90 to about 95 wt. % (by total weight of the granule) of sulfur;
comprises at least about 8 wt. % (by total weight of the granule) of bentonite;
has a diameter within the range of about 2 to about 4 mm;
has a crush strength of at least about 3.0 kgf, preferably at least about 3.2 kgf, preferably of at least about 3.4 kgf, more preferably of at least about 3.6 kgf; and
is characterized by a fraction of at least about 40 wt. % preferably at least about 45 wt. %, more preferably at least about 48.5 wt. %, most preferably at least about 50 wt. % of particles having a particle size of less than about 315 micron when tested according to the degradation test protocol described herein.

Preferably there is provided a sulfur fertilizer granule which:
comprises about 90 to about 95 wt. % (by total weight of the granule) of sulfur;
comprises at least about 4 wt. % (by total weight of the granule) of bentonite, preferably at least about 8 wt. %;
has a diameter within the range of about 2 to about 4 mm;
has a crush strength of at least about 3.4 kgf, more preferably of at least about 3.6 kgf; and
is characterized by a fraction of at least about 40 wt. % preferably at least about 45 wt. %, more preferably at least about 48.5 wt. %, most preferably at least about 50 wt. % of particles having a particle size of less than about 315 micron when tested according to the degradation test protocol described herein.

In preferred embodiments of the invention, the sulfur fertilizer granule has a moisture content of less than about 0.3 wt. % (by total weight of the granule), preferably less than about 0.2 wt. % (by total weight of the granule), more preferably less than about 0.15 wt. % (by total weight of the granule), even more preferably less than about 0.12 wt. % (by total weight of the granule).

A bulk composition comprising a plurality of the sulfur fertilizer granules described herein is also provided. The composition preferably comprises at least about 50 wt. % (by total weight of the composition) of the sulfur fertilizer granules, preferably at least about 75 wt. % (by total weight of the composition) of the sulfur fertilizer granules, more preferably at least about 95 wt. % (by total weight of the composition) of the sulfur fertilizer granules. As will be understood by the skilled person, in case the sulfur fertilizer granules of the invention are mixed with another granular fertilizer at a 50:50 (w:w) ratio, then a bulk composition comprising about 50 wt. % (by total weight of the composition) of the sulfur fertilizer granules is obtained. Similarly, in case the sulfur fertilizer granules are simply produced and packaged as such, then a bulk composition comprising essentially 100 wt. % (by total weight of the composition) of the sulfur fertilizer granules is obtained. In some highly preferred embodiments of the invention there is provided a bulk composition which consists essentially of the sulfur fertilizer granules described herein. The bulk composition described herein may be packaged, e.g. in 50 kg bags, or in bulk bags (so called big-bags) having a volume of at least 0.6m³ . Alternatively, the bulk composition can be provided directly into the loading bed of a truck without including additional packaging.

In preferred embodiments of the invention, the composition described herein has a tapped bulk density of at least 1.1 kg/L, preferably at least 1.2 kg/L, more preferably at least 1.3 kg/L. The tapped bulk density is preferably in the range of 1.15-1.3 kg/L. This is particularly applicable if the bulk composition comprises at least 95 wt. % (by total weight of the composition) of the sulfur fertilizer granules, preferably if the bulk composition consists essentially of the sulfur fertilizer granules. Preferably, the tapped bulk density is determined by placing 100 gram of the composition into a graduated cylinder, securing the cylinder on a tapped bulk density measurement apparatus (e.g. Quantochrome Autotap), tapping 1000 times, determining the tapped volume, and calculating the density, wherein the tapped bulk density is reported as the average of three repeats.

The preferred moisture content outlined herein earlier for the sulfur fertilizer granule is equally applicable to the bulk composition described herein. Hence the composition comprising a plurality of the sulfur fertilizer granules preferably has a moisture content of less than about 0.3 wt. % (by total weight of the composition), preferably less than about 0.2 wt. % (by total weight of the composition), more preferably less than about 0.15 wt. % (by total weight of the composition), even more preferably less than about 0.12 wt. % (by total weight of the composition). This is particularly applicable if the bulk composition comprises at least about 95 wt. % (by total weight of the composition) of the sulfur fertilizer granules, preferably if the bulk composition consists essentially of the sulfur fertilizer granules.

The composition is preferably characterized by having an average crush strength, determined by testing the crush strength of 30 random granules from the composition and calculating the average crush strength, of at least about 3.0 kgf, preferably at least about 3.2 kgf, more preferably of at least about 3.4 kgf, more preferably of at least about 3.6 kgf. This is particularly applicable if the bulk composition comprises at least about 95 wt. % (by total weight of the composition) of the sulfur fertilizer granules, preferably if the bulk composition consists essentially of the sulfur fertilizer granules.

In preferred embodiments of the invention, particularly those embodiments where the fertilizer granule comprises a clay mineral as described herein and the bulk composition consists essentially of the sulfur fertilizer granules, the composition is characterized by a fraction of at least about 40 wt. %, preferably at least about 45 wt. %, more preferably at least about 48.5 wt. %, most preferably at least about 50 wt. % of particles having a particle size of less than about 315 micron when tested according to the degradation test protocol described herein.

The term “composition” and “bulk composition” as described herein are used interchangeably.

### The Method for the Production of Sulfur Fertilizer Granules

In a further aspect of the invention, there is provided a method for the production of a sulfur fertilizer granule comprising the following steps:
(a) providing a molten sulfur stream comprising at least about 90 wt. % (by total weight of the molten sulfur stream) sulfur;
(b) providing an aqueous cooling stream;
(c) continuously feeding the molten sulfur stream of step (a) and the aqueous cooling stream of step (b) to a rotary drum granulator;
(d) continuously rotating the rotary drum granulator, thereby continuously forming sulfur fertilizer granules;
   characterized in that
   the molten sulfur stream of step (a) is fed to the rotary drum granulator in step (c) at a temperature within the range of 130-145° C.; and
   the ratio B: A is in the range of 0.018 to 0.068 liter/kg,
   wherein A is the feed rate of the molten sulfur stream (a), expressed in kg/minute,
   wherein B is the feed rate of the aqueous cooling stream (b), expressed in liter/minute.

The methods described herein allow the production of the high crush strength sulfur fertilizer granule described herein earlier. The sulfur fertilizer granule produced by this method, is thus preferably the sulfur fertilizer granule described herein earlier. In some embodiments of the invention the method described herein is thus a method for the production of a sulfur fertilizer granule having one or more of the properties described herein earlier (e.g. relating to its composition, crush strength, etc.).

The principle of rotary drum granulation is known to the skilled person and is described in detail in WO2009/155682A1, U.S. Pat. Nos. 6,749,659B1, and 4,507,335A, each of which are incorporated herein by reference.

In step (c) the molten sulfur stream (a) and the aqueous cooling stream (b) are sprayed through nozzles mounted in the interior of the rotary drum. The nozzle are preferably fan-type nozzles. The nozzles are preferably placed at a plurality of positions along the length of the rotary drum granulator. As is known to the skilled person, the drum of a rotary drum granulator is a substantially cylindrical vessel placed horizontally. The length of the drum runs along the horizontal plane. The bed of fertilizer granules is, due to the rotary action of the drum, moved along the length of the drum to an outlet of the drum (typically falling into an exit chute). The falling curtain of fertilizer particles grows in granule size as it moves through the drum and passes multiple spray nozzles spraying molten sulfur and aqueous cooling. The movement of the bed through the drum to the outlet is achieved by a slight inclination of the drum and/or the lay-out of the internal flights. In order to achieve stable granulation, the portion of the drum opposite to the outlet side may be continuously fed with seed material (typically recycled undersize granules or recycled oversize granules after crushing), although this is not strictly required as the spray nozzles may be finetuned to increase cooling and achieve seed generation in a zone of the drum (as is described in detail in WO2009155682A1). In the methods of the present invention it is preferred that seed material having a size of 2 mm or less is continuously fed to the granulation drum.

The cooling stream of step (b) is typically water, but does not need to be demineralized water. Lower purity grades of water such as process water, ground water, surface water, etc. can be used. The water content is preferably at least 96 wt. % (by total weight of the aqueous stream), the remaining 4 wt. % being minerals and other impurities.

In preferred embodiments, step (d) comprises rotating the drum at a rotation speed suitable to create a stable falling curtain of fertilizer granules. As will be understood by the person skilled in the art, each granulation drum typically has a window of drum speeds wherein a stable falling curtain of fertilizer granules can be achieved. Within this window, increased drum speed reduces the residence time inside the granulator and thus reduces the obtained particle size, and vice versa.

In a preferred embodiment of the invention, the molten sulfur stream of step (a) is fed to the rotary drum granulator in step (c) at a temperature within the range of 132-138° C. As is shown in the appended examples, lowering the temperature to this range has a large effect on the amount of rework required. Sulfur obtained from industrial processes (like the Claus process) comprises entrapped H₂S. The present inventors have found that degassing the sulfur before using it in the process of the present invention is important not only for health and safety reasons, but may affect the crush strength of the granules. Hence it is preferred that the sulfur comprised in the molten sulfur stream provided in step (a) has been subjected to a step of degassing the molten sulfur in order to reduce the amount of H₂S in the molten sulfur. In some embodiments, explained herein elsewhere, the method of the present invention includes a step of degassing the molten sulfur.

In preferred embodiments of the invention, the ratio B: A is in the range of 0.018 to 0.058 L/kg. In some embodiments of the invention, the ratio B: A is in the range of 0.018 to 0.027 L/kg. As is shown in the appended examples, this flow rate may further contribute to improving the amount of product within the range of about 2 to about 4 mm produced.

In a preferred embodiment, the aqueous cooling stream of step (b) is fed to the rotary drum granulator in step (c) at a temperature within the range of 15-50° C., preferably 20-50° C., and more preferably within the range of 25-45° C.

The inventors have found that specific ventilation of the drum is also relevant to achieve a stable production of high hardness granules. Hence, in preferred embodiments of the invention, the granulator is ventilated at a rate in the range of 250-600 V_{gran}/hour wherein V_{gran} is the interior granulator volume, preferably at a rate between 300 to 500 V_{gran}/hour, more preferably at a rate between 350 to 450 V_{gran}/hour. Ventilation can simply be performed using ambient air. Ventilation thus comprises forcing ambient air through the granulator, using a ventilator or other means known to the skilled person. The ventilation direction through the drum is not limiting and ventilation can be counter or concurrent to the movement of the bed. In some embodiments of the invention, the air stream exiting the granulator is treated to remove entrailed sulfur, H₂S and/or SO₂, for example using a venturi nozzle, a bag house, a jacketed cyclone or a packed bed reactor. The ambient air used for ventilation preferably has a temperature within the range of 5-50° C., preferably within the range of 20-50° C., more preferably within the range of 20-45° C.

The inventors have found that specific granulation bed temperatures are also relevant to achieve a stable production of high hardness granules. Granulation bed temperature is mostly controlled by controlling the sulfur stream temperature, cooling water temperature, and ventilation rates as explained herein before. In preferred embodiments of the invention, the granulator bed temperature is within the range of 60-75° C.

The methods of the invention preferably comprise the use of a granulator drum having an interior volume within the range of 12-16 m³ such as 13-15 m³ employing a feed rate of the molten sulfur stream of step (a) within the range of 8000-12000 kg/hour, preferably within the range of 9000-11000 kg/hour, more preferably within the range of 9500-10500 kg/hour.

In highly preferred embodiments of the invention, the molten sulfur stream of step (a) comprises a clay mineral. The clay mineral is preferably a swelling clay, such as a clay selected from kaolinites, illites, chlorites, vermiculites, and smectites (such as montmorillonites), and more preferably a clay mineral selected from smectites, such as montmorillonites. The clay is most preferably bentonite. The the molten sulfur stream of step (a) preferably comprises at least about 4 wt. % (by total weight of the stream) of the clay mineral, preferably at least about 8 wt. % (by total weight of the stream) of the clay mineral. Thus, the the molten sulfur stream of step (a) preferably comprises at least about 4 wt. % (by total weight of the stream) bentonite, preferably at least about 8 wt. % bentonite.

In some embodiments of the invention, the molten sulfur stream of step (a) consists essentially of sulfur, such that the molten sulfur stream of step (a) comprises at least about 95 wt. % (by total weight of the stream) sulfur, preferably at least about 98 wt. % (by total weight of the stream) sulfur, more preferably at least about 99 wt. % (by total weight of the stream) sulfur.

In preferred embodiments of the invention, the molten sulfur stream of step (a) comprises clay as described herein earlier, and comprises about 90 to about95 wt. % (by total weight of the stream) sulfur.

In highly preferred embodiments, stream (a) consists essentially of sulfur and the clay wherein the combined amount of sulfur and clay by total weight of stream (a) is more than about 98 wt. %, preferably about 99 wt. % and most preferably more than about 99.5 wt. %. In preferred embodiments, stream (a) consists essentially of sulfur and bentonite wherein the combined amount of sulfur and bentonite by total weight of stream (a) is more than about 98 wt. %, preferably about 99 wt. % and most preferably more than about 99.5 wt. %.

As will be understood from the above, preferred embodiments of the method are provided wherein
the molten sulfur stream of step (a) is fed to the rotary drum granulator in step (c) at a temperature within the range of 130-145° C., preferably at a temperature within the range of 132-138° C.;
the ratio B: A is in the range of 0.018 to 0.068 liter/kg, preferably in the range of 0.018 to 0.058 L/kg;
the aqueous cooling stream of step (b) is fed to the rotary drum granulator in step (c) at a temperature within the range of 20-50° C., preferably within the range of 25-45° C.; and
the granulator is ventilated at a rate in the range of 250-600 V_{gran}/hour wherein V_{gran}is the interior granulator volume, preferably at a rate between 300 to 500 V_{gran}/hour, more preferably at a rate between 350 to 450 V_{gran}/hour.
   Further preferred embodiments of the method if the invention, as will be understood from the above, are these wherein:
the molten sulfur stream of step (a) is fed to the rotary drum granulator in step (c) at a temperature within the range of 130-145° C., preferably at a temperature within the range of 132-138° C.;
the ratio B: A is in the range of 0.018 to 0.068 liter/kg, preferably in the range of 0.018 to 0.058 L/kg;
the aqueous cooling stream of step (b) is fed to the rotary drum granulator in step (c) at a temperature within the range of 20-50° C., preferably within the range of 25-45° C.;
the granulator is ventilated at a rate in the range of 250-600 V_{gran}/hour wherein V_{gran} is the interior granulator volume, preferably at a rate between 300 to 500 V_{gran}/hour, more preferably at a rate between 350 to 450 V_{gran}/hour;
the molten sulfur stream of step (a) comprises a clay mineral, and comprises about 90 to about 95 wt. % (by total weight of the stream) sulfur.
   Further preferred embodiments of the method if the invention, as will be understood from the above, are these wherein:
the molten sulfur stream of step (a) is fed to the rotary drum granulator in step (c) at a temperature within the range of 130-145° C., preferably at a temperature within the range of 132-138° C.;
the ratio B: A is in the range of 0.018 to 0.068 liter/kg, preferably in the range of 0.018 to 0.058 L/kg;
the aqueous cooling stream of step (b) is fed to the rotary drum granulator in step (c) at a temperature within the range of 20-50° C., preferably within the range of 25-45° C.;
the granulator is ventilated at a rate in the range of 250-600 V_{gran}/hour wherein V_{gran}is the interior granulator volume, preferably at a rate between 300 to 500 V_{gran}/hour, more preferably at a rate between 350 to 450 V_{gran}/hour;
the molten sulfur stream of step (a) comprises at least about 4 wt. % (by total weight of the stream) bentonite, preferably at least about 8 wt. % bentonite, and comprises about 90 to about 95 wt. % (by total weight of the stream) sulfur.

In some embodiments of the invention, the method does not comprise the application of a dedusting oil as described herein earlier, such that the obtained sulfur fertilizer granule is essentially free of dedusting oils, in particular vegetable oil.

In some preferred embodiments of the invention, the method is provided wherein the molten sulfur stream of step (a) comprises a clay mineral and wherein step (a) comprises the steps:
(a1) providing sulfur;
(a2) providing the clay mineral; and
(a3) mixing the sulfur with the clay mineral at a temperature above the melting point of sulfur.

In preferred embodiments of the invention, step (a1) comprises a step of degassing the molten sulfur in order to reduce the amount of H₂S in the molten sulfur. Suitable degassing techniques include chemical degassing using catalyst beds, physical degassing with squash plates, mesh plates, mesh pads or spray nozzles, forcing air through the molten sulfur, or combinations thereof. In preferred embodiments, degassing comprises forcing air through the molten sulfur. The degassing is preferably performed until sampling of an air stream passed through the molten sulfur shows a H₂S concentration of less than 10 ppmv. Degassing is preferably performed in case the sulfur has been produced from refinery gas streams, in particular in case the sulfur has been produced via the Claus process.

In preferred embodiments, step (a3) is performed in a stirred tank. The stirred tank is preferably continuously stirred or agitated such that the clay remains suspended in the molten sulfur until it enters the granulator drum.

In preferred embodiments of the invention, the method further comprises the step:
(a) recovering sulfur fertilizer granules from the rotary drum granulator.

In preferred embodiments, step (e) comprises separating the recovered sulfur fertilizer granules into a first fraction having a size within a predetermined size range, a second fraction having a size larger than the upper boundary of the predetermined size range and a third fraction having a size smaller than the lower boundary of the predetermined size range. In such embodiments, the predetermined size range is highly preferably from about 2 to about 4 mm in diameter. The granulation bed is discharged from the drum and conveyed to a size-separation operation configured to recover particles having a size within the predetermined size range. The size-separation operation preferably comprises screening and more preferably comprises double deck screening. In some embodiments of the invention, the second fraction and third fraction are returned to step (a) of the process for recycling. In case the predetermined size range is from about 2 to about 4 mm, the second fraction comprises particles below about 2 mm in diameter, whilst the third fraction comprises particles above about 4 mm in diameter.

The oversize fraction (the third fraction) can be submitted to crushing before it is returned to the granulator. However, preferably, the step of recycling the second and third fraction to step (a) of the process comprises remelting at least the third fraction, thereby avoiding a crushing step. Remelting can be performed in a dedicated rework tank, or in a tank receiving molten sulfur feed.

As is shown in the appended examples, the methods of the present invention minimize rework, in particular in case the predetermined size range is from about 2 to about 4 mm. Hence, in highly preferred embodiments of the invention, the first fraction represents more than about 80 wt. % of the recovered sulfur fertilizer granules, preferably the first fraction represents more than about 85 wt. % of the recovered sulfur fertilizer granules, and more preferably the first fraction represents more than about 90 wt. % of the recovered sulfur fertilizer granules.

### Sulfur Fertilizer Granule Obtainable by the Method Described Herein

In another aspect the invention provides a sulfur fertilizer granule obtainable by the method described herein. The sulfur fertilizer granule obtainable by the method described herein corresponds to the sulfur fertilizer granule described herein earlier, and thus preferably has one or more of the properties described herein earlier (e.g. relating to its composition, crush strength, etc.).

### Uses and Methods of the Sulfur Fertilizer Granule

In another aspect, the invention concerns the use of the sulfur fertilizer granule of the invention as a fertilizer. In an embodiment of the invention there is provided the use of the sulfur fertilizer granule of the invention for providing nutrients to plants. In particular, there is provided the use of the sulfur fertilizer granule of the invention for fertilization through broadcast application.

In another aspect, the invention concerns a method of fertilizing plants comprising application of the sulfur fertilizer granule of the invention, preferably application to soil. Application is preferably through broadcast application.

The invention is further described by the following aspects:
1. A sulfur fertilizer granule comprising at least 90 wt. % (by total weight of the granule) of sulfur and having a crush strength of at least 3.0 kgf.
2. the sulfur fertilizer granule of aspect 1 having a crush strength of at least 3.2 kgf.
3. The sulfur fertilizer granule of aspect 2 having a crush strength of at least 3.6 kgf.
4. The sulfur fertilizer granule of any one of the previous aspects having a diameter within the range of 2-4 mm.
5. The sulfur fertilizer granule of any one of the previous aspects further comprising a clay mineral.
6. The sulfur fertilizer granule of aspect 5 wherein the clay mineral is selected from kaolinites, illites, smectites and montmorillonites.
7. The sulfur fertilizer granule of aspect 6 wherein the clay mineral is bentonite.
8. The sulfur fertilizer granule of any one of the previous aspects comprising 90-95 wt. % (by total weight of the granule) sulfur.
9. The sulfur fertilizer granule of any one of the previous aspects, preferably aspect 8 comprising at least 4 wt. % (by total weight of the granule) bentonite.
10. The sulfur fertilizer granule of aspect 9 comprising at least 8 wt. % (by total weight of the granule) bentonite.
11. The sulfur fertilizer granule of any one of the previous aspects which further comprises a vegetable oil coating.
12. A composition comprising a plurality of sulfur fertilizer granules of any one of aspects 1-11.
13. The composition of aspect 12 comprising at least 50 wt. % (by total weight of the composition) of the sulfur fertilizer granules.
14. The composition of aspect 12 or 13 having a moisture content of less than 0.3 wt. % (by total weight of the composition).
15. The composition of any one of aspects 12-14 having a tapped bulk density of more than 1.1 kg/L.
16. A method for the production of a sulfur fertilizer granule comprising the following steps:
   (a) providing a molten sulfur stream comprising at least 90 wt. % (by total weight of the molten sulfur stream) sulfur;
   (b) providing an aqueous cooling stream;
   (c) continuously feeding the molten sulfur stream of step (a) and the aqueous cooling stream of step (b) to a rotary drum granulator;
   (d) continuously rotating the rotary drum granulator, thereby continuously forming sulfur fertilizer granules;
      characterized in that
      the molten sulfur stream of step (a) is fed to the rotary drum granulator in step (c) at a temperature within the range of 130-145° C.; and
      the ratio B: A is in the range of 0.018 to 0.068 liter/kg,
      wherein A is the feed rate of the molten sulfur stream (a), expressed in kg/minute,
      wherein B is the feed rate of the aqueous cooling stream (b), expressed in liter/minute.
17. The method of aspect 16 wherein the molten sulfur stream of step (a) is fed to the rotary drum granulator in step (c) at a temperature within the range of 132-138° C.
18. The method of aspect 16 or 17 wherein the sulfur comprised in the molten sulfur stream provided in step (a) has been subjected to a step of degassing the molten sulfur in order to reduce the amount of H₂S in the molten sulfur.
19. The method of any one of aspects 16-18 wherein the ratio B: A is in the range of 0.018 to 0.027 liter/kg.
20. The method of any one of aspects 16-19 wherein the granulator is ventilated at a rate in the range of 250-600 V_{gran}/hour wherein V_{gran} is the interior granulator volume.
21. The method of any one of aspects 16-20 wherein the granulator bed temperature is within the range of 65-75° C.
22. The method of any one of aspects 16-21 wherein the aqueous cooling stream of step (b) is fed to the rotary drum granulator in step (c) at a temperature within the range of 20-50° C.
23. The method of aspect 22 wherein the aqueous cooling stream of step (b) is fed to the rotary drum granulator in step (c) at a temperature within the range of 25-45° C.
24. The method of any one of aspects 16-23 wherein the molten sulfur stream comprises 90-95 wt. % (by total weight of the stream) sulfur.
25. The method of any one of aspects 16-24 wherein the molten sulfur stream further comprises a clay mineral.
26. The method of aspect 25 wherein the clay mineral is selected from kaolinites, illites, smectites and montmorillonites.
27. The method of aspect 26 wherein the clay mineral is bentonite.
28. The method of aspect 27 wherein the molten sulfur stream comprises at least 4 wt. % (by total weight of the stream) bentonite.
29. The method of aspect 28 wherein the molten sulfur stream comprises at least 8 wt. % (by total weight of the stream) bentonite.
30. The method of any one of aspects 16-29 wherein step (c) is performed using a plurality of spray nozzles placed at a plurality of positions along the length of the rotary drum granulator
31. The method of aspects 25-29 wherein step (a) comprises the steps:
   (a1) providing sulfur;
   (a2) providing the clay mineral; and
   (a3) mixing the sulfur with the clay mineral at a temperature above the melting point of sulfur.
32. The method of aspect 31 wherein the step (a1) comprises providing molten sulfur and further comprises a step of degassing the molten sulfur in order to reduce the amount of H₂S in the molten sulfur.
33. The method of aspect 32 wherein the degassing step comprises forcing air through the molten sulfur.
34. The method of any one of aspects 16-33 wherein the method further comprises the step:
   (e) recovering sulfur fertilizer granules from the rotary drum granulator.
35. The method of aspect 34 wherein step (e) comprises separating the recovered sulfur fertilizer granules into a first fraction having a size within a predetermined size range, a second fraction having a size larger than the upper boundary of the predetermined size range and a third fraction having a size smaller than the lower boundary of the predetermined size range.
36. The method of aspect 35 wherein the predetermined size range is from 2 to 4 mm.
37. The method of aspect 35 or 36 wherein separating the recovered sulfur fertilizer granules into the first, second and third fraction comprises screening
38. The method of aspect 37 comprising screening using double deck screens.
39. The method of any one of aspects 35-38 wherein the second fraction and third fraction are returned to step (a) of the process for recycling.
40. The method of any one of aspects 35-39 35 wherein the first fraction represents more than 80 wt. % of the recovered sulfur fertilizer granules.

41. A sulfur fertilizer granule obtainable by the method of any one of aspects 16-40.
42. A method of fertilizing plants comprising application of the sulfur fertilizer granule of any one of aspects 1-15 or 41 to soil.

### EXAMPLES

### Degradation Test Protocol

20 gram of sulfur fertilizer is combined with 10 ml deionized (DI) water without stirring in a petri dish (diameter 100 mm and height of 40 mm) by first adding the sulfur fertilizer to the petri dish in an approximately even layer before adding the DI water into the petri dish. The sulfur fertilizer is allowed to swell at room temperature for a period of 24 hours. Following this the sulfur fertilizer is dried overnight at 40° C., gently removed from the petri dish and sieved using a sieve of 315 micron. The mass of the particle fractions passing through the sieve and retained by the sieve respectively are determined and the relative amounts calculated in wt. %.

### Example 1

In a rotary drum granulator having a volume of about 14m³ , a molten sulfur stream comprising 94.7 wt. % sulfur and about 5 wt. % bentonite was sprayed at a rate of 9979 kg/hour (also referred to as A, the feed rate of the molten sulfur stream). The sulfur stream originated from a Claus process and was degassed to a H₂S content of the degassing air stream exiting the sulfur melt of less than 10 ppmv. The molten sulfur stream is fed to the rotary drum granulator at a temperature within the range of 132-138° C.

Water is sprayed in the rotary drum granulator at a rate of 204 L/hour (also referred to as B, the feed rate of the aqueous cooling stream) and a temperature of 20-40° C. The ratio of B: A is 0.020 litre/kg.

Ventilation was applied at a rate of about 420 times the reactor volume per hour.

88wt. % of the resulting particles were in the size range between 2 to 4 mm, whilst 8 wt. % had a particle size greater than 4 mm, and 4 wt. % had a size range below 2 mm. A random sampling of 30 granules within the size range of about 2 to about 4 mm showed an average hardness of 3.62 kgf as determined with the Torontech portTAB-01.

### Example 2

In a rotary drum granulator having a volume of about 14m³ , a molten sulfur stream comprising 92.4 wt. % sulfur and about 7.5 wt. % bentonite was sprayed at a rate of 9979 kg/hour (also referred to as A, the feed rate of the molten sulfur stream). The sulfur stream originated from a Claus process and was degassed to a H₂S content of the degassing air stream exiting the sulfur melt of less than 10 ppmv. The molten sulfur stream is fed to the rotary drum granulator at a temperature within the range of 132-143° C.

Water is sprayed in the rotary drum granulator at a rate of 295 L/hour (also referred to as B, the feed rate of the aqueous cooling stream) and a temperature of 20-40° C.

The ratio of B: A is 0.030 litre/kg.

Ventilation was applied at a rate of about 420 times the reactor volume per hour.

55 wt. % of the resulting particles were in the size range between 2 to 4 mm, whilst 10 wt. % had a particle size greater than 4 mm, and 35 wt. % had a size range below 2 mm. A random sampling of 30 granules within the size range of 2 to 4 mm showed an average hardness of 3.77 kgf as determined with the Torontech portTAB-01.

### Example 3

In a rotary drum granulator having a volume of about 14m³ , a molten sulfur stream comprising 90 wt. % sulfur and about 10 wt. % bentonite was sprayed at a rate of 9979 kg/hour (also referred to as A, the feed rate of the molten sulfur stream). The sulfur stream originated from a Claus process and was degassed to a H₂S content of the degassing air stream exiting the sulfur melt of less than 10 ppmv. The molten sulfur stream is fed to the rotary drum granulator at a temperature within the range of 132-138° C.

Water is sprayed in the rotary drum granulator at a rate of 340 L/hour (also referred to as B, the feed rate of the aqueous cooling stream)and a temperature of 20-40° C.

The ratio of B:A is 0.034 litre/kg.

Ventilation was applied at a rate of about 390 times the reactor volume per hour.

A random sampling of 30 granules within the size range of about 2 to about 4 mm showed an average hardness of 3.5 kgf as determined with the Torontech portTAB-01.

### Example 4 (Degradation Tests)

The degradation test protocol was carried out on the sulfur fertilizer granules of example 3. It was found that 49.8 wt. % of particles have a particle size of more than 315 micron, and 50.2 wt. % of particles have a particle size of less than 315 micron.

Commercial product Keg90S® was purchased from Keg River. This product consists of sulfur fertilizer pastilles comprising about 89.6 wt. % sulfur and about 10.4 wt. % so this bentonite having an average particle size of 2.4 mm and an average hardness of 3.3 kgf as determined with the Torontech portTAB-01. The degradation test protocol was carried out on the Keg90S® product. It was found that 55.6 wt. % of particles have a particle size of more than 315 micron, and 44.4 wt. % of particles have a particle size of less than 315 micron.

Commercial product Tiger 90CR® was purchased from Tiger-Sul. This product consists of sulfur fertilizer pastilles comprising about 90 wt. % sulfur and about 10 wt. % bentonite having an average particle size of 2.1 mm and an average hardness of 2.7 kgf as determined with the Torontech portTAB-01. The degradation test protocol was carried out on the Tiger 90CR® product. It was found that 52.2 wt. % of particles have a particle size of more than 315 micron, and 47.8 wt. % of particles have a particle size of less than 315 micron.

1. A sulfur fertilizer granule comprising at least 90 wt. % (by total weight of the granule) of sulfur and having a crush strength of at least 3.0 kgf.

2. The sulfur fertilizer granule of claim 1 having a crush strength of at least 3.2 kgf.

3. The sulfur fertilizer granule of claim 2 having a crush strength of at least 3.6 kgf.

4. The sulfur fertilizer granule of claim 1 having a diameter within the range of 2 to 4 mm.

5. The sulfur fertilizer granule of claim 1 further comprising a clay mineral.

6. The sulfur fertilizer granule of claim 5, wherein the clay mineral is bentonite.

7. The sulfur fertilizer granule of claim 1 which further comprises a vegetable oil coating.

8. The sulfur fertilizer granule of claim 1 characterized by a fraction of at least 40 wt. % of particles having a particle size of less than 315 micron when tested according to the degradation test protocol of the description.

9. The sulfur fertilizer granule of claim 1 which:
comprises 90 to 95 wt. % (by total weight of the granule) of sulfur;
comprises at least 4 wt. % (by total weight of the granule) of bentonite;
has a diameter within the range of 2 to 4 mm;
has a crush strength of at least 3.2 kgf; and
is characterized by a fraction of at least 40 wt. % of particles having a particle size of less than 315 micron when tested according to the degradation test protocol described herein.

10. (canceled)

11. A method for the production of a sulfur fertilizer granule comprising the following steps:
(a) providing a molten sulfur stream comprising at least 90 wt. % (by total weight of the molten sulfur stream) sulfur;
(b) providing an aqueous cooling stream;
(c) continuously feeding the molten sulfur stream of step (a) and the aqueous cooling stream of step (b) to a rotary drum granulator;
(d) continuously rotating the rotary drum granulator, thereby continuously forming sulfur fertilizer granules;
characterized in that
the molten sulfur stream of step (a) is fed to the rotary drum granulator in step (c) at a temperature within the range of 130-145° C.; and
the ratio B:A is in the range of 0.018 to 0.068 liter/kg,
wherein A is the feed rate of the molten sulfur stream (a), expressed in kg/minute,
wherein B is the feed rate of the aqueous cooling stream (b), expressed in liter/minute.

12. The method of claim 11, wherein the molten sulfur stream of step (a) is fed to the rotary drum granulator in step (c) at a temperature within the range of 132-138° C.

13. The method of claim 11 wherein the ratio B:A is in the range of 0.018 to 0.058 L/kg.

14. The method of claim 11 wherein the granulator is ventilated at a rate in the range of 250-600 V_{gran}/hour wherein V_{gran} is the interior granulator volume.

15. The method of claim 11 wherein the granulator bed temperature is within the range of 65-75° C.

16. The method of claim 11 wherein the aqueous cooling stream of step (b) is fed to the rotary drum granulator in step (c) at a temperature within the range of 20-50° C.

17. The method of claim 11 wherein the molten sulfur stream comprises 90-95 wt. % (by total weight of the stream) sulfur.

18. The method of claim 11 wherein the molten sulfur stream further comprises a clay mineral.

19. The method of claim 18 wherein the clay mineral is bentonite.

20. The method of claim 18 wherein step (a) comprises the steps:
(a1) providing sulfur;
(a2) providing the clay mineral; and
(a3) mixing the sulfur with the clay mineral at a temperature above the melting point of sulfur.

21. The method of any of claim 11, wherein the step (a) or step (a1) comprises providing molten sulfur and further comprises a step of degassing the molten sulfur in order to reduce the amount of H₂S in the molten sulfur.

22.-28. (canceled)
